(19) United States
(12) Patent Application Publication
(10) Pub. No.: US 2019/0249360 A1
(43) Pub. Date: Aug. 15, 2019

(54) Method And System For Tagging Leather Or Hides Treated With Biocide And Identifying Same

(71) Applicant: Buckman Laboratories International, Inc., Memphis, TN (US)

(72) Inventors: Luis A. Zugno, Germantown, TN (US); Philip M. Hoekstra, Memphis, TN (US)

(73) Assignee: Buckman Laboratories International, Inc., Memphis, TN (US)

(21) Appl. No.: 16/264,714

(22) Filed: Feb. 1, 2019

Related U.S. Application Data
(60) Provisional application No. 62/630,846, filed on Feb. 15, 2018.

(51) Int. Cl. D06P 1/00; A01N 47/14; A01N 43/78; A01N 43/82; A01N 47/48; A01N 31/08; A01N 43/80; A01N 47/40; A01N 33/20; A01N 43/40; C14C 9/00; G01N 21/64; G01N 21/31

(52) U.S. Cl. CPC D06P 1/0012; A01N 47/14; A01N 43/78; A01N 43/82; A01N 47/48; A01N 31/08; G01N 2021/6439; A01N 47/40; A01N 33/20; A01N 43/40; C14C 9/00; G01N 21/6428; G01N 21/31; A01N 43/80

(57) ABSTRACT

A method of treating leather or hide is provided whereby a biocide and one or more detectable tags are applied to a piece of leather or hide. The detectable tag(s) can be detected to indicate one or more pieces of information, such as that the biocide has been applied to the piece of leather or hide and/or other information. Information about the biocide and the tannery that applied the biocide or other information can be discerned from detecting the detectable tag or from one or more of the detectable tags if used. A system for tagging leather or hide and applying a biocide are also provided as are methods and systems for detecting the tags.

This application claims the benefit under 35 U.S.C. § 119(e) of prior U.S. Provisional Patent Application No. 62/630,846 filed Feb. 15, 2018, which is incorporated in its entirety by reference herein.

### FIELD OF THE INVENTION

The present invention relates to tagging leathers or hides that have been treated with a biocide preparation, and identifying tagged leathers or hides.

### BACKGROUND OF THE INVENTION

Conventionally, when tanning raw hides to produce leather, biocide preparations are added to the tanning drum to prevent spoilage of the leather during storage and transport. This is done through a batch process. In order to certify that a biocide, such as a fungicide, has been applied to a piece of leather, the piece of leather must be removed from the drum and analyzed with reagents. This is a laborious and skilled test that only few tanneries perform. After leather storage, the determination of whether a biocide has been applied is only available by extraction and high-performance liquid chromatography (HPLC) analysis that requires sophisticated equipment, is costly and takes time. Furthermore, this analysis cannot determine what biocide was applied in the tannery.

A need exists for an easier, quicker, and less expensive method for determining whether a biocide has been applied to a piece of leather, and optionally what biocide was applied in the tannery, and/or optionally the supplier or provider of the biocide.

### SUMMARY OF THE INVENTION

The present invention provides an easy, quick, and inexpensive method and system for determining whether a biocide has been applied to leather or hides. The present invention provides a method and system to identify the tannery that applied the biocide and/or the supplier or provider of the biocide. The method relies on the addition of one or more tags to a biocide preparation, or the separate application of a tag, to indicate that a biocide has been applied to the leather or hide. A detection method and system are also provided that can use a hand-held device or other detection set-up to check for a signal, such as fluorescence, to determine if a tag (and thus the biocide) was applied to the leather (or hide), or not. A detector can be incorporated into a wringing machine, where, during a wringing operation, a facility can achieve 100% inspection of leather (or hide) pieces to determine if a biocide has been applied to leather (or hide), or not.

The hand-held device or other detection system can comprise an excitation source configured to emit radiation at an excitation wavelength that, for example, triggers fluorescence of a fluorescent tag or that reflects a spectroscopic signal. Detection of such fluorescence or other signal can be made by visual inspection or by an optical system, for example, including a charge-coupled device such as a camera or other device. The present method and system can also determine what type of biocide has been applied.

If customized, or using more than one tag, the tags can be used to determine if the leather or hide is applied with biocide, and/or what the biocide is, and/or whether the biocide is sufficiently present on the leather or hide, and/or what tannery or tannery group applied the biocide and/or who produced the biocide-treated leather or hide and/or the provider or supplier of the biocide.

The tag can be a rare earth element, an oxide or salt thereof, a coded particle, a tracer, a fluorescent molecule or moiety, or any combinations thereof. Customized tags unique to a particular customer or particular tannery, or particular biocide provider can be provided.

Unique blends of various tags can be used to provide unique “signatures” that differentiate a biocide and tannery from others.

These and other advantages and objectives of the present invention will become even more apparent from the drawings appended hereto and the detailed description that follows, that are intended to exemplify, not limit, the present teachings.

### BRIEF DESCRIPTION OF THE DRAWINGS

The present invention can be even more fully understood with the reference to the accompanying drawings which are intended to illustrate, not limit, the present invention.

FIG. 1 is a flow chart showing the steps involved in a method according to one or more embodiments of the present invention.

FIG. 2 is a flow chart showing the steps involved in another method according to one or more embodiments of the present invention.

FIG. 3 is a flow chart showing the steps involved in yet another method according to one or more embodiments of the present invention.

FIG. 4 is a flow chart showing the steps involved in yet another method according to one or more embodiments of the present invention.

FIG. 5 is a flow chart showing the steps involved in yet another method according to one or more embodiments of the present invention.

FIG. 6 is a flow chart showing the steps involved in yet another method according to one or more embodiments of the present invention.

### DETAILED DESCRIPTION OF THE INVENTION

According to one aspect of the present invention, a method of treating leather or hide is provided that comprises applying a biocide to a piece of leather or hide and applying a detectable tag to the piece of leather or hide to indicate that the biocide has been applied. The detectable tag can be a unique tag that is specific to the particular biocide applied, or to the tannery that applied the biocide, or to the biocide provider or manufacturer or any combinations thereof. One tag can provide one or more items of information, or two or more different tags can be used to convey multiple items of information. The tag can be part of the biocide or present along with the biocide or, the detectable tag can be applied before or after the biocide is applied, or at the same time that the biocide is applied. Thereafter, at the same or any different processing or handling facility, the detectable tag can be detected using an appropriate detection system or device. Accordingly, through one or two or more tags, one can determine a) whether a biocide has been applied, and/or b) the tannery where a biocide was applied, and/or c) what kind of biocide has been applied, and/or d) the provider or supplier of the biocide, and/or e) when the biocide was applied and the like, and/or f) if sufficient biocide has been applied (concentration) and/or g) if biocide has been uniformly applied on the leather or hide (e.g., 100% or near 100% of the surface of the leather or hide treated with biocide). As an option, and as an example, the method can involve applying a first detectable tag to indicate the type, composition, batch/lot, or preparation of the biocide applied, and a second detectable tag to indicate where the biocide was applied.

The method can comprise detecting the detectable tag by any suitable method, depending upon the chemistry, composition, and/or structure of the detectable tag. For example, colorimetric detection methods can be used, fluorometric analysis methods can be used, spectrophotometric methods can be used, microscopic analysis methods can be used, combinations thereof, and the like.

The detectable tag can comprise a fluorescent dye or other material and the detection method can comprise irradiating the piece of leather or hide with ultraviolet light and detecting fluorescence indicative of the presence of the fluorescent dye or material.

Fluorescent dyes or other materials that emit radiation at a different wavelength than the excitation wavelength, can be used.

The detectable tag can comprise indicia formed of a detectable dye or other material (e.g., fluorescent dye), for example, printed onto the piece of leather or hide as a two-dimensional bar code.

The detectable tag can be a nano-sized tag or a sub-nano sized tag. The detectable tag can be a chemical tag. The detectable tag can be an electronic tag. The detectable tag can be a physical tag. The detectable tag can be a taggant. The detectable tag can be a unique combination of detectable levels of magnetic, electromagnetic, ferromagnetic and/or other metal alloy materials that provide a unique chemical or physical or wavelength or electronic signature. The chemical tag can be lipophilic and/or organic or inorganic and the like. The detectable tag can be a fiber or chip or other shape.

The detectable dye can comprise a nanobarcode structure embedded, adhered, or otherwise fixed to the piece of leather or hide and which can be detected by a spectrophotometric or microscopic analysis method. The detecting can comprise irradiating a piece of leather or hide with an excitation source and then detecting a specific wavelength of radiation emitting from the piece of leather or hide upon being irradiated.

The detection method can comprise comparing the specific wavelength emitted from the piece of leather or hide to known wavelengths corresponding to known detectable tags. Based on such a comparison, the detectable tag corresponding to the specific wavelength emitted, can be determined. Detecting a specific wavelength can involve visually inspecting visible light emitted from the piece of leather or hide. Irradiating the piece of leather or hide can comprise directing radiation emitted from an excitation source toward the piece of leather or hide, for example, directing radiation emitted from an excitation source, at the piece of leather or hide. The excitation source can comprise an LED light source, a laser light source, an incandescent light source, and/or a fluorescent light source.

The detectable tag or multiple tags can be applied by any suitable method. The detectable tag(s) and a binder can be dissolved in a solvent or dispersed in a vehicle to form a tagging composition, for example, a tagging solution or a tagging liquid. The tagging composition can then be applied to a piece of leather or hide in a manner, and under conditions, such that the binder affixes the detectable tag to the piece of leather or hide. The detectable tag(s) can be dissolved or dispersed in a solvent or a liquid to form a tagging composition that can be applied to a piece of leather or hide, without a binder. The tagging composition can comprise one or more different detectable tags, for example, two different detectable molecules or particles. The detectable tag(s) can, itself, be biocidal or non-biocidal. The detectable tag(s) can be inert. The detectable tag(s) can comprise an encoded nanoparticle, a fluorescent tracer, a lanthanide series element, quantum dots, detectable inert chemical or composition, or the like. The detectable tag(s) can comprise a fluorescent lanthanide chelate of dibenzoylamine.

The biocide can comprise any suitable leather-safe biocide known to those of skill in the art. The biocide preparations can be or include potassium N-hydroxymethyl-N-methyl dithiocarbamate, 2-thiocyanomethylthiobenzothiazole, propiconazole, sodium 2-mercaptobenzothiazole, S-chloromethyl-S′-hexylcyanodithioimidocarbonate, p-chloro-meta-cresol, o-phenyl-phenol, 2-n-octyl isothiazolinone, methylenebisthiocyanate, chloro-2-methyl-4-isothiazolin-3-one, 2-methyl-4-isothiazolin-3-one, 2-bromo-2-nitro-1,3-propanediol, sodium 2-pyridienethiol-1-oxide, or propiconazole or any mixture thereof.

The biocide can be applied to the piece of leather or hide by being incorporated into a float containing leather or hide tanning agents. Alternatively, the biocide can be applied before or after the piece of leather or hide is tanned in a tanning float. The biocide can be part of a biocidal composition comprising a liquid vehicle, a leather-safe leather-treating biocide, and a detectable tag. The liquid vehicle can comprise a solvent. The solvent can comprise an aqueous system.

As an option, the detectable tag(s) can be present with the biocidal composition. For instance, the detectable tag(s) can be dispersed with or mixed in with a biocide composition before the biocidal composition is applied to the leather or hide. The detectable tag(s) can be chemically bound, ionically bound, absorbed, adsorbed, dispersed therein, or otherwise associated with biocidal composition so that the tag(s) is (are) present essentially where the biocidal composition is present on the leather or hide.

The detectable tag(s) can be of a volume such that the detectable tag is distributed in the same locations as the biocide so as to provide or coincide with biocide locations and thus provide the ability to determine if, the biocide application was sufficient (e.g., concentration and/or surface coverage) in treating the leather or hide. In the alternative, the detectable tag can be one or two or more tags and used more for determining more generally if the biocide was applied to the leather or hide at all.

The biocidal preparation can be emulsion and the detectable tag(s) can be present in the emulsion.

The biocidal preparation can be water soluble and the detectable tag(s) can be present in the water soluble preparation.

The biocidal preparation or a part thereof can be lipophilic and the detectable tag(s) can be lipophilic as well, or have a coating on the detectable tag(s) that is lipophilic. As one option, the biocidal preparation is lipophilic and on treating the leather or hide, primarily locates itself on the fat containing parts of the leather or hide. The biocide can solubilize, attach, or otherwise dissolve into the fat containing parts to stay present on the leather or hide. When the detectable tag is present or dispersed with this type of biocide, the detectable tag can be very representative of the biocide applied and/or where the biocide is located and/or how uniform the biocide application is to the leather or hide surface(s).

In order to determine which tannery, from a plurality of tanneries, has applied a biocide to a piece of leather or hide, the present methods can involve applying a first biocide and a first detectable tag to a first piece of leather (or hide) at a first tannery, and applying a second biocide and a second detectable tag to a second piece of leather (or hide) at a second tannery. The first and second biocides can be the same as, or different from, each other. The second detectable tag can be different from the first detectable tag. As such, at a downstream processing or handling facility, a piece of leather or hide can be inspected to determine the presence of the first or second detectable tag. Thus, by such inspection, it can be determined which tannery applied the biocide to the piece of leather or hide. Such a method can ensure that a biocide has been applied to the piece of leather or hide and can pin-point the tannery that applied the biocide. If the detectable tag comprises information about a lot number, other pieces of leather or hide from the same lot can be identified, and, for example, graded, gathered, or recalled as needed or desired. Other detectable tags and corresponding detecting methods are described in more detail below.

Biocides and biocide preparations that can be used in the methods of the present invention include those described in U.S. Patent Application Publication Nos. US 2001/0031775 A1 to King et al., US 2004/0084383 A1 to Zhou et al., US 2006/0289354 A1 to Zhou et al., US 2008/0241247 A1 to Marais et al., US 2008/0230094 A1 to Zhou et al., and US 2010/0173018 A1 to Marais, and in U.S. Pat. No. 4,945,109 to Rayudu, U.S. Pat. No. 5,401,881 to Puckett et al., U.S. Pat. No. 5,466,717 to Rayudu et al., U.S. Pat. No. 5,494,904 to Oppong et al., U.S. Pat. No. 5,681,851 to Lee et al., U.S. Pat. No. 5,703,131 to Puckett et al., U.S. Pat. No. 5,874,453 to Oppong et al., U.S. Pat. No. 5,902,820 to Jacquess et al., U.S. Pat. No. 6,034,081 to Whittemore et al., U.S. Pat. No. 6,235,299 B1 to King et al., U.S. Pat. No. 6,241,994 B1 to Lee et al., and U.S. Pat. No. 6,576,629 B1 to Oppong et al., each of which is incorporated herein in its entirety by reference.

Exemplary taggants, tracers, and other identifiable chemicals, structures, and devices that can be used for tagging, tracing, or identification in accordance with the present invention, include those described in U.S. Patent Application Publication Nos. US 2005/0032226 A1 to Natan, US 2012/0205449 A1 to Lewis et al., US 2014/0001261 A1 to Tan et al., US 2015/0323465 A1 to Natan et al., and US 2016/0018404 A1 to Iyer et al., and in U.S. Pat. No. 3,412,245 to Halverson, U.S. Pat. No. 3,422,023 to Kleinerman, U.S. Pat. No. 3,500,047 to Berry, U.S. Pat. No. 4,966,711 to Hoots et al., U.S. Pat. No. 5,200,106 to Hoots et al., U.S. Pat. No. 5,279,967 to Bode, U.S. Pat. No. 5,411,889 to Hoots et al., U.S. Pat. No. 5,677,186 to Anderson, II et al., U.S. Pat. No. 7,842,516 B2 to Dejneka et al., U.S. Pat. No. 9,139,768 to Talyansky et al., U.S. Pat. No. 9,097,670 to Talyansky et al., U.S. Pat. No. 9,322,709 to Talyansky et al., US 2017/0348994 to Talyansky et al., US 2016/0252455 to Talyansky et al., US 2015/0369659 to Talyansky et al., US 2015/0324677 to Talyansky et al., US 2015/0302675 to Talyansky et al., US 2015/0225643 to Talyansky et al., and U.S. Pat. No. 9,528,144 B2 to Bisso et al., each of which is incorporated herein in its entirety by reference.

Many different ways to detect and quantitate the tags can be used, and the detection systems can implement any of a variety of methods and properties. The detectable tag can comprise a taggant material that is invisible in light of the visible spectrum and fluoresces under a non-visible excitation energy. The tag can be part of a taggant composition that also comprises a binder and a solvent in which the tag and the binder are dissolved. The taggant composition can be printed or otherwise applied to a piece of leather or hide to provide a detectable and identifiable indicium. Methods and apparatus for detecting and decoding detectable tag indicium can include those described in U.S. Patent Application Publication No. US 2012/0205449 A1 to Lewis et al., which is incorporated herein in its entirety by reference.

The detectable tag can be applied by a printer. Multiple printer heads can be used that are run by a single controller and the controller can be run by a single computer. At low resolution, readable patterns, such as barcodes, can be printed. An exemplary set-up for applying barcodes includes a 72-inch frame with 12 fixed ink jet printheads. As the leather or hide moves along the frame, a given barcode can be printed in a square array of barcodes on 6-inch centers. In this fashion, 36 of the same barcodes can be printed per square yard of leather or hide. The choice of spacing and the corresponding number of barcodes per square yard of leather or hide can depend upon the final use of the detectable tag and the costs of printing the tag.

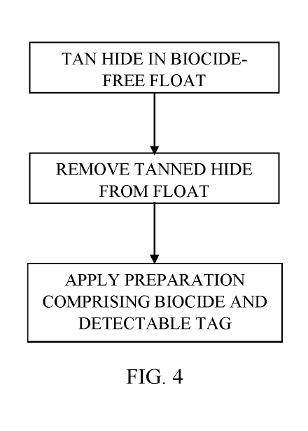

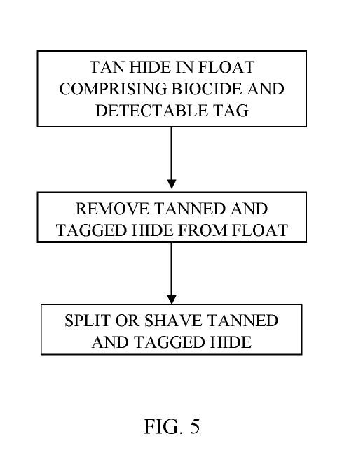

The detection system can be capable of exciting the tag and subsequently detecting, storing, and decoding the indicium of the tag. The detection system can include an apparatus for reading the tag. An exemplary device can include a housing including an emitter capable of emitting the excitation energy to induce the tag material to fluoresce. The device can further include a detector that detects a fluorescing tag material upon excitation by the emitted energy from emitter. Internally, the device can include a processing chip or other data processor coupled with a recordable medium including software for a pattern recognition module for detecting and/or decoding the indicium, and a display module for displaying the indicium or the corresponding information to a user. The device can include a user interface screen and an activation button for activating the device to read and/or decode a tag. An exemplary hand-held device is described in and shown in FIGS. 4 and 5 of U.S. Patent Application Publication No. US 2012/0205449 A1 to Lewis et al., which is incorporated herein in its entirety by reference.

Quantitation of a detectable tag can be made on the basis of the fluorescence intensity emanating from a particular tag, for example, from a nanobarcode. Fluorescence from a molecular or particulate fluorescent tag can be detected, or from the intensity of differential reflectivity. Reflectivity can be used to identify a nanobarcode. A variety of other schemes can be used both for quantitation and tag flavor identification. Different detection methods and systems can be used for different tag types. The detection can be for tags comprising fluorescent tags, electrochemical tags, radioactive tags, mass tags (such as those used in mass spectrometry), other molecular tags (such as those used in combinatorial chemistry), or other particulate tags. Likewise, for nanobarcode identification, a variety of detection mechanisms can be used, including, but not limited to, optical detection mechanisms (absorbance, fluorescence, Raman, hyperRaman, Rayleigh scattering, hyperRayleigh scattering, CARS, sum frequency generation, degenerate four wave mixing, forward light scattering, back scattering, or angular light scattering), scanning probe techniques (near field scanning optical microscopy, AFM, STM, chemical force or lateral force microscopy, and other variations), electron beam techniques (TEM, SEM, FE-SEM), and electrical, mechanical, and magnetic detection mechanisms (including SQUID).

For tags comprising nanobarcodes, free-standing particles comprising a plurality of segments can be used. Exemplary particle lengths of from 10 nm to 50 microns and particle widths of from 5 nm to 50 microns can be used. The segments of the particles can comprise different materials. Included among the possible materials are metals, metal chalcogenides, metal oxides, metal sulfides, metal selenides, metal tellurides, metal alloys, metal nitrides, metal phosphides, metal antimonides, semiconductors, semi-metals, organic compounds or materials, inorganic compounds or materials, particulate layers of material, and composite materials. The segments of the particles can comprise polymeric materials, crystalline or non-crystalline materials, amorphous materials or glasses. The particles can be functionalized to include organic compounds, and/or inorganic compounds. Such functionalization can result in a detectable tag or a species that binds a detectable tag.

The tag can be one or more particles (e.g., inorganic) that can be separately applied to the leather or hide and/or added to the biocide to be applied. The tag particles can be one or more types of rare earth doped ceramics or other inorganic materials.

The tag can comprise an assembly or collection of particles comprising a plurality of types of particles, wherein each particle is from 10 nm to 50 microns in length and is comprised of a plurality of segments. The types of particles can be differentiable. The particle types can be differentiable based on differences in the length, width, or shape of the particles and/or the number, composition, length, or pattern of segments. The particles can be differentiable based on the nature of their functionalization or physical properties, for example, as measured by mass spectrometry or light scattering.

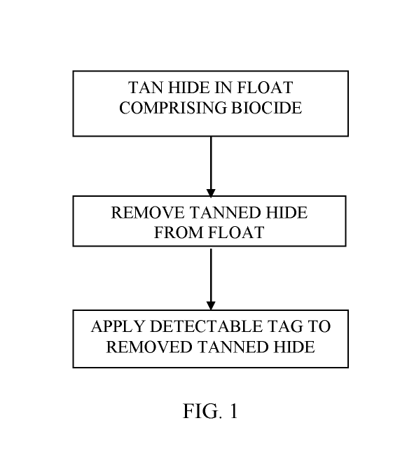

With reference now to the figures, FIG. 1 is a flow chart depicting an embodiment of the present invention wherein a post-treatment of a tanned hide, with a detectable tag, is provided. One or more leather-treating biocides are included in a tanning liquor or float in which a raw hide is to be tanned. The biocide is thus applied to the hide simultaneously with the tanning liquor. After removing a tanned hide from the tanning liquor or float, a detectable tag is then applied to the removed tanned hide, according to the present invention. The detectable tag can be dissolved or dispersed in a tagging composition or solution that is applied to the removed tanned hide. The detectable tag can be applied as a neat tagging composition, applied by printing to form indicia, or fixed to the removed tanned hide by using a binder.

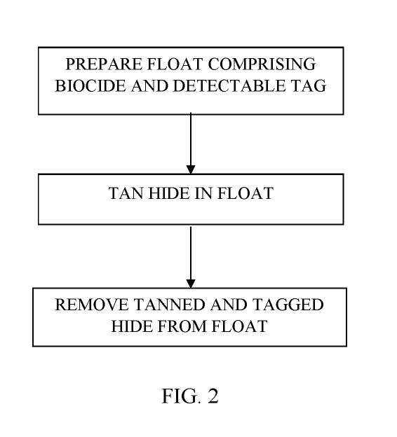

FIG. 2 is a flow chart depicting a method of the present invention, similar to that depicted in FIG. 1, but, wherein, rather than being applied through a post-treatment procedure, the detectable tag is included with a biocide in the tanning liquor. The biocide and detectable tag are thus applied simultaneously with the tanning liquor.

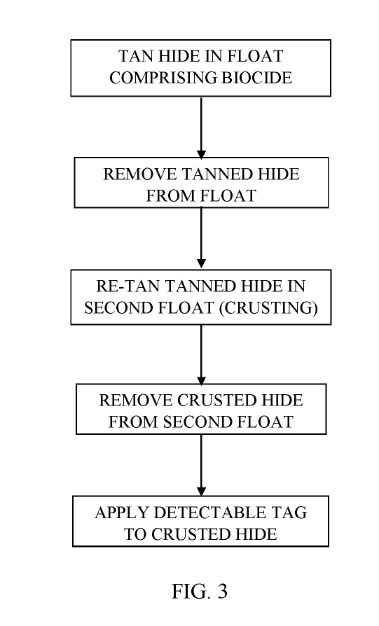

FIG. 3 is a flow chart depicting yet another embodiment of the present invention, which includes a crusting step. Crusting can comprise re-tanning a tanned hide, in a second tanning liquor or float. Subsequent to crusting, the crusted hide is removed from the second float, before the detectable tag is applied according to the present invention. Alternatively, the detectable tag can be included with, or separately from, a biocide, in either the first float or the second float or both.

FIG. 4 is a flow chart depicting yet another embodiment of the present invention, whereby the tanning liquor or float may or may not contain a biocide. After tanning, the tanned hide can be removed from the float and then a biocide and tagging preparation comprising, consisting of, or consisting essentially of, a biocide and a detectable tag, is applied to the tanned hide. The biocide and tagging preparation can be applied to one or more of the surfaces (e.g., top and/or bottom or portion thereof) of the tanned hide and can be applied together or in sequential steps (e.g., biocide then tag or tag then biocide, or together). A transfer roll-coating or immersion technique can be used, for example, to apply the biocide and tagging preparation to the tanned hide. Transfer roll-coating using a pair of nip rollers can be used to apply the biocide and tagging preparation to both major surfaces of the tanned hide, simultaneously.

FIG. 5 is a flow chart depicting yet another embodiment of the present invention, similar to the embodiment depicted in FIG. 2, but further including a splitting or shaving step. A tanning liquor or float is first prepared that includes a biocide and tagging preparation, and then a raw hide is tanned in the float. The resulting tanned hide is then removed from the float, and thereafter the removed tanned hide is then split or shaved. Although not depicted, the method can further include applying more biocide and tagging preparation to the newly exposed surface of the split or shaved, removed tanned hide, which newly exposed surface results from the splitting or shaving. Application of the biocide and tagging preparation can be accomplished by a transfer roll-coating or immersion technique although other techniques for applying the biocide and tagging preparation can instead be used.

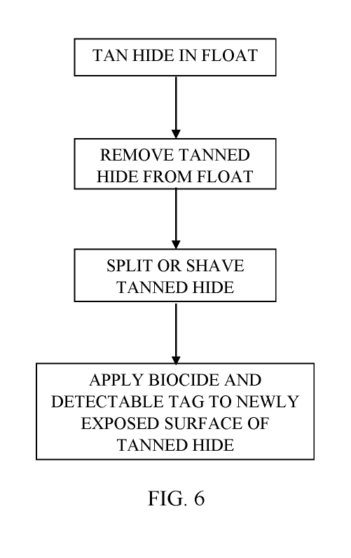

FIG. 6 is a flow chart depicting yet another embodiment of the present invention including a splitting or shaving step performed on the tanned hide after the tanned hide is removed from the float and before a post-treatment application of a biocide and tagging preparation. In particular, the biocide and tagging preparation can be applied to the newly exposed surface of the tanned hide, resulting from the splitting or shaving step. Even if a biocide, detectable tag, or both, are included in the tanning liquor or float, full penetration of the biocide through the entire thickness of the hide may not be achieved. If not, then the newly exposed surface resulting from splitting or shaving may not include a biocide content sufficient to provide prolonged preservation of the newly exposed surface. The post-treatment application of the biocide and tagging preparation ensures that even a newly exposed surface resulting from splitting or shaving is preserved and tagged. If a biocide is also present in the float, the post-treatment application of the biocide and tagging preparation can use the same biocide that is used in the float, or a second, different biocide. After splitting or shaving, a biocide and tagging preparation can be applied to only the newly exposed surface such that only one surface of the resulting leather or hide would be tagged with the detectable tag. If two or more different biocides are used, a single detectable tag can be used to denote that the multi-biocide application of biocides has occurred.

With the present invention, and using one or more detectable tags, various advantages are achieved, including, but not limited to:
Confirming on site in the tannery that 100% (or other sufficient surface area) of the leather or hide has been treated properly (e.g., sufficient or proper amount of biocide and/or sufficient surface area of leather/hide has biocide present) with a biocide (e.g., fungicide). This has the advantage of giving 100% assurance of protection before the leather or hide is shipped (e.g., before wet blue leather is shipped for finishing). Thus, with the present invention, this is a method that gives immediate confirmation, preventing waste and preventing quality problems.
Identifying which biocide (e.g., fungicide) product has been used. As an option, each proprietary biocide (e.g., fungicide) can have its own tag identifier.
The present invention provides an alternative to the current method of confirming that there is enough fungicide in the leather or hide (e.g. wet blue) to protect it. Currently, samples of the leather or hide are taken, and two methods may be used. Samples can be subjected to a moist warm environment and any growth of mold after 6 weeks can be observed. Or the samples may be sent to an external supporting laboratory, where complex procedures are implemented to confirm that the leather or hide is protected. Also, some commercial fungicides break down and are not amenable to measuring by extraction and analysis. Either of these existing methods are time consuming and expensive. The present invention provides a more rapid solution and permits confirmation at the location of where the biocide is applied.
As an option, with the present invention, there can be a specific tag identification pattern that distinguishes the site at which the leather or hide was produced—traceability. The advantage for the leather or hide producer is ability to identify which tannery is the source of a particular batch. A key is authenticity—the company that purchases the tanned hide for conversion into consumer goods will be able to confirm the source of the raw material. This will be useful for solving quality problems, determining methods to produce the best product, and/or to help deal with counterfeiting of consumer products.
With the present invention, for the supplier of the biocide (e.g., fungicide), the present invention will help confirm (1) that the leather or hide was indeed treated with a biocide(s) (e.g., one or more fungicides), and/or (2) if the leather or hide was indeed treated with product from this particular supplier—related to claims and liability.

The present invention includes the following aspects/embodiments/features in any order and/or in any combination:

1. A method of treating leather or hide, comprising:

applying a biocide to a piece of leather or hide; and

applying one or more detectable tags to the piece of leather or hide, wherein the one or more detectable tags convey a) whether a biocide has been applied, and/or b) the tannery where a biocide was applied, and/or c) what kind and/or other details of biocide applied, and/or d) the provider or supplier of the biocide, and/or e) when the biocide was applied, and/or f) if sufficient biocide has been applied (concentration) and/or g) if biocide has been uniformly applied on the leather or hide (e.g., surface coverage) or any combination thereof.

2. The method of any preceding or following embodiment/feature/aspect, further comprising detecting the detectable tag on or in the piece of leather or hide.
3. The method of any preceding or following embodiment/feature/aspect, wherein the detecting comprises a colorimetric detection method, fluorometric analysis, a spectrophotometric method, a microscopic analysis, or a combination thereof.
4. The method of any preceding or following embodiment/feature/aspect, wherein the biocide and the detectable tag are combined together in a biocidal tagging composition that is applied to the piece of leather or hide such that the biocide and the detectable tag are applied simultaneously to the piece of leather or hide.
5. The method of any preceding or following embodiment/feature/aspect, wherein the biocide and the detectable tag are applied sequentially to the piece of leather or hide.
6. The method of any preceding or following embodiment/feature/aspect, wherein the biocide is first applied to the piece of leather or hide and then the detectable tag is applied to the piece of leather or hide.
7. The method of any preceding or following embodiment/feature/aspect, wherein the detecting comprises:

irradiating the piece of leather or hide with an excitation source; and

detecting a specific wavelength of radiation emitting from the piece of leather or hide upon being irradiated.

8. The method of any preceding or following embodiment/feature/aspect, further comprising:

comparing the specific wavelength to known wavelengths corresponding to known detectable tags; and

determining, based on the comparing, the detectable tag corresponding to the specific wavelength.

9. The method of any preceding or following embodiment/feature/aspect, wherein the detecting a specific wavelength comprises visually inspecting the visible light emitted from the piece of leather or hide.
10. The method of any preceding or following embodiment/feature/aspect, wherein the irradiating the piece of leather or hide comprises directing radiation emitted from an excitation source, at the piece of leather or hide.
11. The method of any preceding or following embodiment/feature/aspect, wherein the excitation source comprises an LED light source, a laser light source, or a combination thereof.
12. The method of any preceding or following embodiment/feature/aspect, wherein the applying the detectable tag comprises creating an indicia on the piece of leather or hide, with a florescent dye.
13. The method of any preceding or following embodiment/feature/aspect, wherein applying the detectable tag comprises:

dissolving the detectable tag and a binder in a solvent to form a tagging solution; and

applying the tagging solution to the piece of leather or hide to affix the detectable tag to the piece of leather or hide.

14. The method of any preceding or following embodiment/feature/aspect, wherein the detectable tag comprises at least two different detectable molecules or particles.
15. The method of any preceding or following embodiment/feature/aspect, wherein the detectable tag comprises a lanthanide series element.
16. The method of any preceding or following embodiment/feature/aspect, wherein the detectable tag comprises a fluorescent tracer.
17. The method of any preceding or following embodiment/feature/aspect, wherein the detectable tag comprises an encoded nanoparticle.
18. The method of any preceding or following embodiment/feature/aspect, wherein the detectable tag is non-biocidal.
19. The method of any preceding or following embodiment/feature/aspect, wherein the biocide preparation is or includes potassium N-hydroxymethyl-N-methyl dithiocarbamate, 2-thiocyanomethylthiobenzothiazole, propiconazole, sodium 2-mercaptobenzothiazole, S-chloromethyl-S′-hexylcyanodithioimidocarbonate, p-chloro-meta-cresol, o-phenyl-phenol, 2-n-octyl isothiazolinone, methylenebisthiocyanate, chloro-2-methyl-4-isothiazolin-3-one, 2-methyl-4-isothiazolin-3-one, 2-bromo-2-nitro-1,3-propanediol, sodium 2-pyridienethiol-1-oxide, or propiconazole or any mixture thereof.
20. The method of any preceding or following embodiment/feature/aspect, wherein the applying biocide and the applying detectable tag are carried out at a first leather tannery, and the method further comprises:

applying a second biocide to a second piece of leather or hide at a second leather tannery; and

applying a second detectable tag to the second piece of leather or hide at the second leather tannery, wherein the second detectable tag is different from the first-mentioned detectable tag.

21. The method of any preceding or following embodiment/feature/aspect, further comprising:

detecting the detectable tag on or in the piece of leather or hide, at a third location;

detecting the second detectable tag on the second piece of leather or hide, at the third location, and

determining at least one of (i) where the biocide was applied to the piece of leather or hide, and (ii) where the second biocide was applied to the second piece of leather or hide.

22. A biocidal composition comprising a liquid vehicle, a leather-safe leather-treating biocide, and one or more detectable tags, wherein the one or more detectable tags convey a) whether the biocide has been applied, and/or b) the tannery where the biocide was applied, and/or c) what kind of biocide has been applied, and/or d) the provider or supplier of the biocide, and/or e) when the biocide was applied, and/or f) if sufficient biocide has been applied (concentration) and/or g) if the biocide has been uniformly applied on the leather or hide or any combination thereof.
23. The biocidal composition of any preceding or following embodiment/feature/aspect, wherein the biocide preparation is or includes potassium N-hydroxymethyl-N-methyl dithiocarbamate, 2-thiocyanomethylthiobenzothiazole, propiconazole, sodium 2-mercaptobenzothiazole, S-chloromethyl-S′-hexylcyanodithioimidocarbonate, p-chloro-meta-cresol, o-phenyl-phenol, 2-n-octyl isothiazolinone, methylenebisthiocyanate, chloro-2-methyl-4-isothiazolin-3-one, 2-methyl-4-isothiazolin-3-one, 2-bromo-2-nitro-1,3-propanediol, sodium 2-pyridienethiol-1-oxide, or propiconazole or any mixture thereof.
24. The biocidal composition of any preceding or following embodiment/feature/aspect, wherein the detectable tag comprises a lanthanide series element.
25. The biocidal composition of any preceding or following embodiment/feature/aspect, wherein the detectable tag comprises a fluorescent tracer.
26. The biocidal composition of any preceding or following embodiment/feature/aspect, wherein the detectable tag comprises an encoded nanoparticle.
27. The biocidal composition of any preceding or following embodiment/feature/aspect, wherein the detectable tag is non-biocidal.
28. The biocidal composition of any preceding or following embodiment/feature/aspect, further comprising at least one binder.
29. The biocidal composition of any preceding or following embodiment/feature/aspect, wherein the biocide preparation is or includes potassium N-hydroxymethyl-N-methyl dithiocarbamate, 2-thiocyanomethylthiobenzothiazole, propiconazole, sodium 2-mercaptobenzothiazole, S-chloromethyl-S′-hexylcyanodithioimidocarbonate, p-chloro-meta-cresol, o-phenyl-phenol, 2-n-octyl isothiazolinone, methylenebisthiocyanate, chloro-2-methyl-4-isothiazolin-3-one, 2-methyl-4-isothiazolin-3-one, 2-bromo-2-nitro-1,3-propanediol, sodium 2-pyridienethiol-1-oxide, or propiconazole or any mixture thereof.
30. The biocidal composition of any preceding or following embodiment/feature/aspect, wherein the detectable tag comprises a fluorescent lanthanide chelate of dibenzoylamine.
31. The method of any preceding or following embodiment/feature/aspect, wherein one detectable tag is utilized and provides at least two of a)-g).
32. The method of any preceding or following embodiment/feature/aspect, wherein two or more detectable tags are utilized and provide at least two of a)-g).
33. The method of any preceding or following embodiment/feature/aspect, wherein two or more detectable tags are utilized and provide at least three of a)-g).
34. The method of any preceding or following embodiment/feature/aspect, wherein two or more detectable tags are utilized and provide at least four of a)-g).
35. The method of any preceding or following embodiment/feature/aspect, wherein two or more detectable tags are utilized and provide at least five of a)-g).
36. A leather or hide comprising leather or hide treated with at least one biocide and one or more detectable tags, wherein the one or more detectable tags convey a) whether the biocide has been applied, and/or b) the tannery where the biocide was applied, and/or c) what kind of biocide has been applied, and/or d) the provider or supplier of the biocide, and/or e) when the biocide was applied, and/or f) if sufficient biocide has been applied (concentration) and/or g) if the biocide has been uniformly applied on the leather or hide or any combination thereof.

The present invention can include any combination of these various embodiments, features, and aspects described above as set-forth in the foregoing sentences and/or paragraphs. Any combination of disclosed features herein is considered part of the present invention and no limitation is intended with respect to combinable features.

The entire contents of all references cited in this disclosure are incorporated herein in their entireties, by reference. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether such ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method of treating leather or hide, comprising:
applying a biocide to a piece of leather or hide; and
applying one or more detectable tags to the piece of leather or hide, wherein the one or more detectable tags convey a) whether the biocide has been applied, and/or b) the tannery where the biocide was applied, and/or c) what kind of biocide has been applied, and/or d) the provider or supplier of the biocide, and/or e) when the biocide was applied, and/or f) if sufficient biocide has been applied (concentration) and/or g) if the biocide has been uniformly applied on the leather or hide or any combination thereof.

2. The method of claim 1, further comprising detecting the detectable tag on or in the piece of leather or hide.

3. The method of claim 2, wherein the detecting comprises a colorimetric detection method, fluorometric analysis, a spectrophotometric method, a microscopic analysis, or a combination thereof.

4. The method of claim 1, wherein the biocide and the detectable tag are combined together in a biocidal tagging composition that is applied to the piece of leather or hide such that the biocide and the detectable tag are applied simultaneously to the piece of leather or hide.

5. The method of claim 1, wherein the biocide and the detectable tag are applied sequentially to the piece of leather or hide.

6. The method of claim 1, wherein the biocide is first applied to the piece of leather and then the detectable tag is applied to the piece of leather or hide.

7. The method of claim 1, wherein the detecting comprises:
irradiating the piece of leather or hide with an excitation source; and
detecting a specific wavelength of radiation emitting from the piece of leather or hide upon being irradiated.

8. The method of claim 7, further comprising:
comparing the specific wavelength to known wavelengths corresponding to known detectable tags; and
determining, based on the comparing, the detectable tag corresponding to the specific wavelength.

9. The method of claim 7, wherein the detecting a specific wavelength comprises visually inspecting the visible light emitted from the piece of leather or hide.

10. The method of claim 7, wherein the irradiating the piece of leather or hide comprises directing radiation emitted from an excitation source, at the piece of leather or hide.

11. The method of claim 10, wherein the excitation source comprises an LED light source, a laser light source, or a combination thereof.

12. The method of claim 1, wherein the applying the detectable tag comprises creating an indicia on the piece of leather or hide, with a florescent dye.

13. The method of claim 1, wherein applying the detectable tag comprises:
dissolving the detectable tag and a binder in a solvent to form a tagging solution; and
applying the tagging solution to the piece of leather or hide to affix the detectable tag to the piece of leather or hide.

14. The method of claim 1, wherein the detectable tag comprises at least two different detectable molecules or particles.

15. The method of claim 1, wherein the detectable tag comprises a lanthanide series element.

16. The method of claim 1, wherein the detectable tag comprises a fluorescent tracer.

17. The method of claim 1, wherein the detectable tag comprises an encoded nanoparticle.

18. The method of claim 1, wherein the detectable tag is non-biocidal.

19. The method of claim 1, wherein the biocide comprises a bromine-containing solution.

20. The method of claim 1, wherein the biocide preparation comprises potassium N-hydroxymethyl-N-methyl dithiocarbamate, 2-thiocyanomethylthiobenzothiazole, propiconazole, sodium 2-mercaptobenzothiazole, S-chloromethyl-S′-hexylcyanodithioimidocarbonate, p-chloro-meta-cresol, o-phenyl-phenol, 2-n-octyl isothiazolinone, methylenebisthiocyanate, chloro-2-methyl-4-isothiazolin-3-one, 2-methyl-4-isothiazolin-3-one, 2-bromo-2-nitro-1,3-propanediol, sodium 2-pyridienethiol-1-oxide, or propiconazole or any mixture thereof.

21. The method of claim 1, wherein the applying biocide and the applying detectable tag are carried out at a first leather tannery, and the method further comprises:
applying a second biocide to a second piece of leather or hide at a second leather tannery; and
applying a second detectable tag to the second piece of leather or hide at the second leather tannery, wherein the second detectable tag is different from the first-mentioned detectable tag.

22. The method of claim 21, further comprising:
detecting the detectable tag on or in the piece of leather or hide, at a third location;
detecting the second detectable tag on the second piece of leather or hide, at the third location, and
determining at least one of (i) where the biocide was applied to the piece of leather or hide, and (ii) where the second biocide was applied to the second piece of leather or hide.

23. A biocidal composition comprising a liquid vehicle, a leather-safe leather-treating biocide, and one or more detectable tags, wherein the one or more detectable tags convey a) whether the biocide has been applied, and/or b) the tannery where the biocide was applied, and/or c) what kind of biocide has been applied, and/or d) the provider or supplier of the biocide, and/or e) when the biocide was applied, and/or f) if sufficient biocide has been applied (concentration) and/or g) if the biocide has been uniformly applied on the leather or hide or any combination thereof.

24. The biocidal composition of claim 23, wherein the biocide preparation comprises potassium N-hydroxymethyl-N-methyl dithiocarbamate, 2-thiocyanomethylthiobenzothiazole, propiconazole, sodium 2-mercaptobenzothiazole, S-chloromethyl-S′-hexylcyanodithioimidocarbonate, p-chloro-meta-cresol, o-phenyl-phenol, 2-n-octyl isothiazolinone, methylenebisthiocyanate, chloro-2-methyl-4-isothiazolin-3-one, 2-methyl-4-isothiazolin-3-one, 2-bromo-2-nitro-1,3-propanediol, sodium 2-pyridienethiol-1-oxide, or propiconazole or any mixture thereof.

25. The biocidal composition of claim 23, wherein the detectable tag comprises a lanthanide series element.

26. The biocidal composition of claim 23, wherein the detectable tag comprises a fluorescent tracer.

27. The biocidal composition of claim 23, wherein the detectable tag comprises an encoded nanoparticle.

28. The biocidal composition of claim 23, wherein the detectable tag is non-biocidal.

29. The biocidal composition of claim 23, further comprising at least one binder.

30. The biocidal composition of claim 23, wherein the biocide comprises: (a) propiconazole; and (b) doedecylamine or a dodecylamine salt selected from the group consisting of dodecylamine acetate, dodecylamine maleate, dodecylamine malonate, dodecylamine propionate, dodecylamine butyrate, dodecylamine citrate, dodecylamine lactate, dodecylamine valerate, dodecylamine phthalate, dodecylamine succinate, dodecylamine hydroxysuccinate, dodecylamine octanoate, dodecylamine nonanate, dodecylamine formate, dodecylamine sorbate, dodecylamine oxalate, dodecylamine laurate, dodecylamine cyclohexanoate, dodecylamine benzoate, dodecylamine 2-hydroxybenzoate, dodecylamine 3-hydroxybenzoate, or dodecylamine 4-hydroxybenzoate.

31. The biocidal composition of claim 23, wherein the detectable tag comprises a fluorescent lanthanide chelate of dibenzoylamine.

32. The method of claim 1, wherein one detectable tag is utilized and provides at least two of a)-g).

33. The method of claim 1, wherein two or more detectable tags are utilized and provide at least two of a)-g).

34. The method of claim 1, wherein two or more detectable tags are utilized and provide at least three of a)-g).

35. The method of claim 1, wherein two or more detectable tags are utilized and provide at least four of a)-g).

36. The method of claim 1, wherein two or more detectable tags are utilized and provide at least five of a)-g).

37. A leather or hide comprising leather or hide treated with at least one biocide and one or more detectable tags, wherein the one or more detectable tags convey a) whether the biocide has been applied, and/or b) the tannery where the biocide was applied, and/or c) what kind of biocide has been applied, and/or d) the provider or supplier of the biocide, and/or e) when the biocide was applied, and/or f) if sufficient biocide has been applied (concentration) and/or g) if the biocide has been uniformly applied on the leather or hide or any combination thereof.
